(19) United States
(12) Patent Application Publication
(10) Pub. No.: US 2022/0385773 A1
(43) Pub. Date: Dec. 1, 2022

(54) DISPLAY DEVICE AND IMAGE FORMING APPARATUS CAPABLE OF DETERMINING WHETHER USER'S HAND HAVING MADE GESTURE IS RIGHT OR LEFT HAND BASED ON DETECTION RESULT OF TOUCH PANEL AND ALLOWING DISPLAY TO DISPLAY SCREEN FOR RIGHT-HAND GESTURE OPERATION OR SCREEN FOR LEFT-HAND GESTURE OPERATION BASED ON DETERMINATION RESULT

(71) Applicant: KYOCERA Document Solutions Inc., Osaka (JP)

(72) Inventor: Tomoki NAKAYA, Osaka (JP)

(73) Assignee: KYOCERA Document Solutions Inc., Osaka (JP)

(21) Appl. No.: 17/751,486

(22) Filed: May 23, 2022

(30) Foreign Application Priority Data
May 28, 2021 (JP) 2021-090535

(51) Int. Cl. H04N 1/00

(52) U.S. Cl. CPC H04N 1/00381; H04N 1/00392; H04N 1/00411; H04N 1/00514; H04N 1/00413

(57) ABSTRACT

A display device includes a display, a touch panel, and a control device. The control device includes a processor and functions as a controller through the processor executing a control program. The controller determines, based on a detection result of a gesture on the touch panel, whether a hand of a user having made the gesture is a right hand or a left hand, and allows the display to display a first screen predetermined for gesture operation with a right hand when determining that the hand having made the gesture is the right hand, or allows the display to display a second screen predetermined for gesture operation with a left hand when determining that the hand having made the gesture is the left hand.

### INCORPORATION BY REFERENCE

This application claims priority to Japanese Patent Application No. 2021-090535 filed on 28 May 2021, the entire contents of which are incorporated by reference herein.

### BACKGROUND

The present disclosure relates to display devices and image forming apparatuses and particularly relates to a technique for switching between display screens.

There is known a technique for determining whether a hand operating a touch panel is a right hand or a left hand. For example, a general technique is known in which, on an individual user basis, a set of information containing an image representing the finger vein of the user and information indicating whether the image is associated with the right hand or left hand of the user is previously registered as finger information, a display device is allowed to display a screen suitable for gesture operation with a right hand when it is determined, based on the finger vein of a user read by a biological information reading device and the stored finger information, that a hand having made a gesture on a touch panel is the right hand of the user, and on the other hand the display device is allowed to display a screen suitable for gesture operation with a left hand when it is determined that the hand having made the gesture is the left hand of the user.

### SUMMARY

A technique improved over the aforementioned technique is proposed as one aspect of the present disclosure.

A display device according to an aspect of the present disclosure includes a display, a touch panel, and a control device. The display displays a screen in a display area thereof. The touch panel is superposed on a top of the display area. The control device includes a processor and functions as a controller through the processor executing a control program. The controller determines, based on a detection result of a gesture on the touch panel, whether a hand of a user having made the gesture is a right hand or a left hand, and allows the display to display a first screen predetermined for gesture operation with a right hand when determining that the hand having made the gesture is the right hand, or allows the display to display a second screen predetermined for gesture operation with a left hand when determining that the hand having made the gesture is the left hand.

An image forming apparatus according to another aspect of the present disclosure includes the above-described display device and an image forming device. The image forming device forms an image on a recording medium.

### BRIEF DESCRIPTION OF THE DRAWINGS

FIG. 1 is a frontal cross-sectional view showing the structure of an image forming apparatus according to a first embodiment of the present disclosure.

FIG. 2 is a block diagram showing an internal configuration of the image forming apparatus.

FIG. 3 is a flowchart showing first gesture hand determination processing.

FIG. 4 is a view showing an example of a touch gesture on a touch panel.

FIG. 5 is a view showing an example of a first screen.

FIG. 6 is a view showing an example of a second screen.

FIG. 7 is a view showing an example of a check screen.

FIG. 8 is a flowchart showing second gesture hand determination processing.

FIG. 9 is a view showing an example of a swipe gesture with a right hand on the touch panel.

FIG. 10 is a view showing another example of the first screen.

### DETAILED DESCRIPTION

### First Embodiment

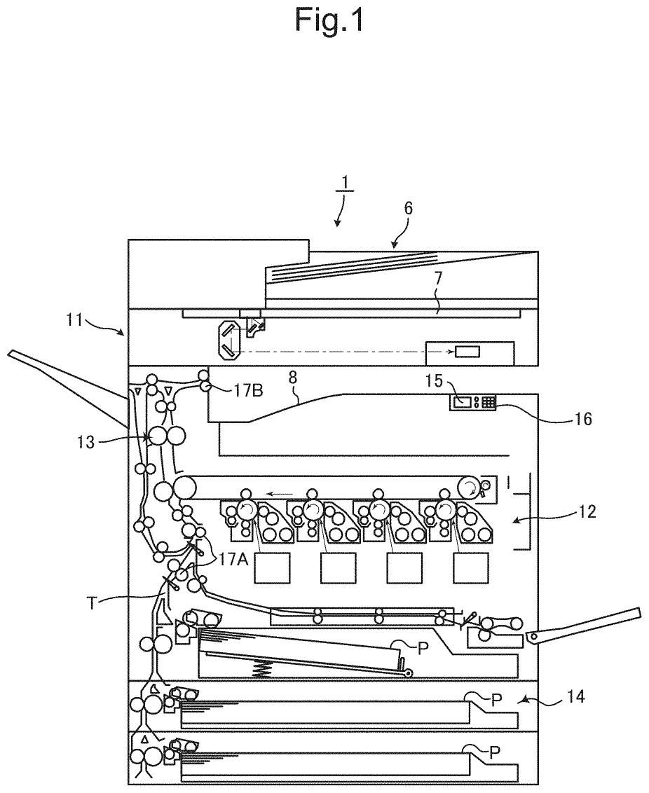

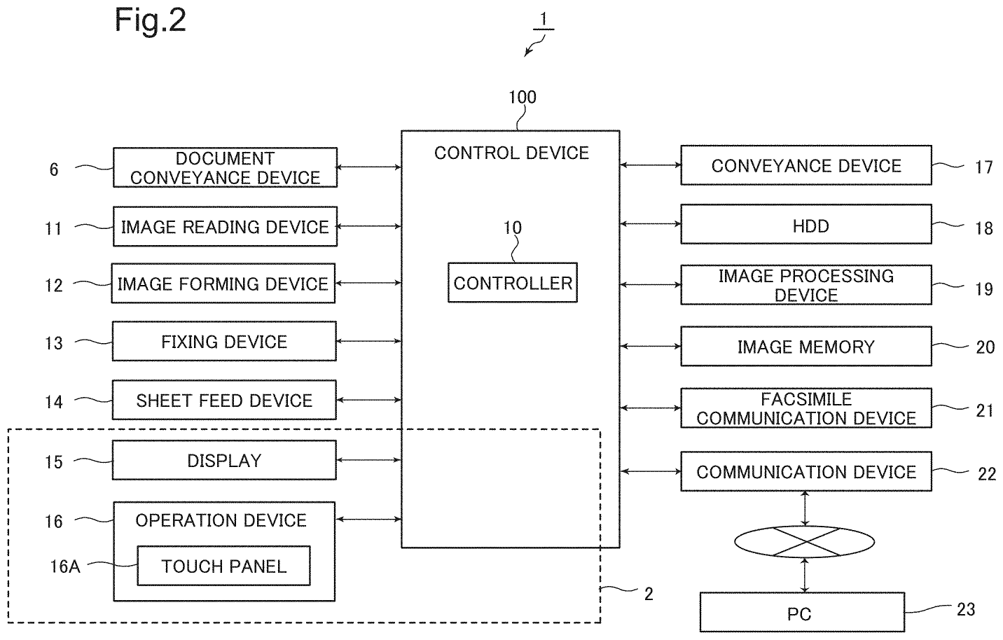

Hereinafter, a description will be given of an image forming apparatus including a display device according to a first embodiment of the present disclosure with reference to the drawings. FIG. 1 is a frontal cross-sectional view showing the structure of an image forming apparatus 1 according to the first embodiment of the present disclosure. FIG. 2 is a block diagram showing an internal configuration of the image forming apparatus 1.

Referring to FIGS. 1 and 2, the image forming apparatus 1 is a multicolor multifunction peripheral having multiple functions, including a copy function, a send function, a print function, and a facsimile function. A housing of the image forming apparatus 1 contains a plurality of devices for use in implementing various functions of the image forming apparatus 1. The housing contains, for example, an image reading device 11, an image forming device 12, a fixing device 13, a sheet feed device 14, and so on.

The image forming apparatus 1 includes a control device 100. The control device 100 includes a processor, a RAM (random access memory), a ROM (read only memory), and so on. The processor is, for example, a CPU (central processing unit), an MPU (micro processing unit), an ASIC (application specific integrated circuit) or the like.

When a control program stored in the ROM or an HDD 18 is executed by the above processor, the control device 100 functions as a controller 10. Alternatively, the controller 10 may not be implemented by the operation of the processor in accordance with the above control program, but may instead be constituted by a logic circuit.

The controller 10 governs the overall operation control of the image forming apparatus 1. More specifically, the controller 10 controls the operations of the devices constituting the image forming apparatus 1 and communications with a PC (personal computer) 23 and other external devices connected via a network. Furthermore, when operating in accordance with a first determination program to be described later, the controller 10 executes first gesture hand determination processing of determining, based on a detection area of a touch gesture of a user on a touch panel 16A, whether a hand of the user having made the gesture is the right hand or the left hand, and (i) allowing a display 15 to display a first screen predetermined for gesture operation with a right hand when determining that the hand having made the gesture is the right hand or (ii) allowing the display 15 to display a second screen predetermined for gesture operation with a left hand when determining that the hand having made the gesture (hereinafter, also referred to simply as the gesture hand) is the left hand.

The control device 100 is electrically connected to a document conveyance device 6, the image reading device 11, the image forming device 12, the fixing device 13, the sheet feed device 14, the display 15, an operation device 16 including the touch panel 16A, a conveyance device 17, an HDD 18, an image processing device 19, an image memory 20, a facsimile communication device 21, a communication device 22, and so on. The display 15, the operation device 16 including the touch panel 16A, and the control device 100 constitutes a display device 2.

The image reading device 11 is an ADF (auto document feeder) including: the document conveyance device 6 that conveys an original document placed on a document loading table; and a scanner that optically reading an original document conveyed by the document conveyance device 6 or an original document placed on a platen glass 7. The image reading device 11 irradiates the original document with light from a lighting part, receives light reflected from the original document on a CCD (charge-coupled device) sensor to read an image of the original document, and thus generates image data representing the image of the original document.

The image forming device 12 includes a plurality of photosensitive drums, charging devices, exposure devices, developing devices, and transfer devices, each provided for a corresponding one of different color toners. The image forming device 12 forms an image formed of a toner image on a recording paper sheet P being conveyed along a conveyance path T by the conveyance device 17, based on the image data generated by the image reading device 11 or image data or the like input through the communication device 22.

The fixing device 13 applies heat and pressure to the recording paper sheet P having the toner image formed thereon by the image forming device 12, thus fixing the toner image on the recording paper sheet P. The recording paper sheet P having the toner image fixed thereon by the fixing device 13 is discharged to a sheet output tray 8.

The sheet feed device 14 includes a manual feed tray and a plurality of sheet feed cassettes. The sheet feed device 14 pulls out recording paper sheets P contained in one of the plurality of sheet feed cassettes or recording paper sheets placed on the manual feed tray, sheet by sheet, with a pick-up roller and feeds forward the pulled-out recording paper sheet to the conveyance path T.

The display 15 is a display composed of a liquid crystal display, an organic EL (an organic light-emitting diode) display or the like. Under the control of the controller 10, the display 15 displays in a display area various screens related to various functions executable by the image forming apparatus 1. In this embodiment, the shape of the display area of the display 15 is a horizontally long shape.

The operation device 16 includes a plurality of hard keys, such as a Start key for instructing to start the execution of various types of processing. The operation device 16 further includes the touch panel 16A superposed on the display area of the display 15. The touch panel 16A to be used is not particularly limited so long as it is of general type, but a touch panel of capacitance type is preferred. The user can input through the operation device 16 various information, including instructions for various functions executable by the image forming apparatus 1.

The conveyance device 17 includes: rollers including conveyance roller pairs 17A and an ejection roller pair 17B; and a conveyance motor connected to the conveyance roller pairs 17A, the ejection roller pair 17B, and the other rollers. The controller 10 drives the conveyance motor to rotate the conveyance roller pairs 17A, the ejection roller pair 17B, and the other rollers, thus allowing the rollers to convey the recording paper sheet P, which has been fed by the sheet feed device 14, toward the image forming device 12 and the sheet output tray 8 along the conveyance path T.

The HDD 18 is a large storage device for use in storing various types of data, including image data generated by the image reading device 11. The HDD 18 stores various control programs for implementing general operations of the image forming apparatus 1. The HDD 18 holds, as one of the various control programs, a first determination program for executing the first gesture hand determination processing according to one embodiment of the present disclosure.

The image processing device 19 performs, as necessary, image processing of image data generated by the image reading device 11. The image memory 20 includes a region that temporarily stores image data generated by the image reading device 11. The facsimile communication device 21 performs connection to a public line and transfers image data to and from other facsimile devices via the public line.

The communication device 22 includes a communication module, such as a LAN (local area network) board. The image forming apparatus 1 performs data communications through the communication device 22 with external devices, such as the PC 23, connected thereto via the network.

Each of the devices constituting the image forming apparatus 1 is connected to a power supply and operates on electric power supplied from the power supply.

[Operations]

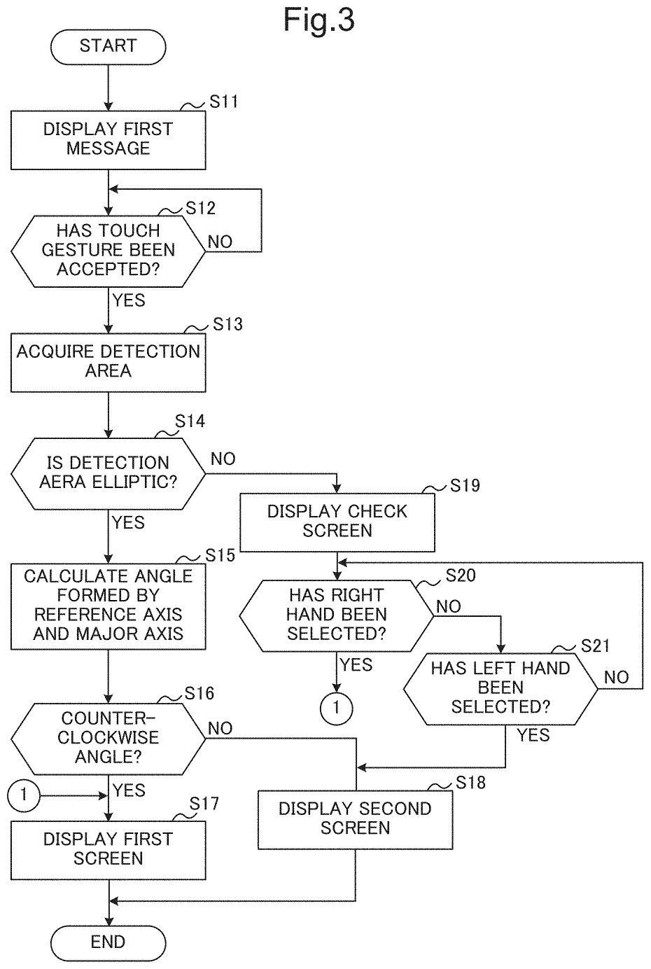

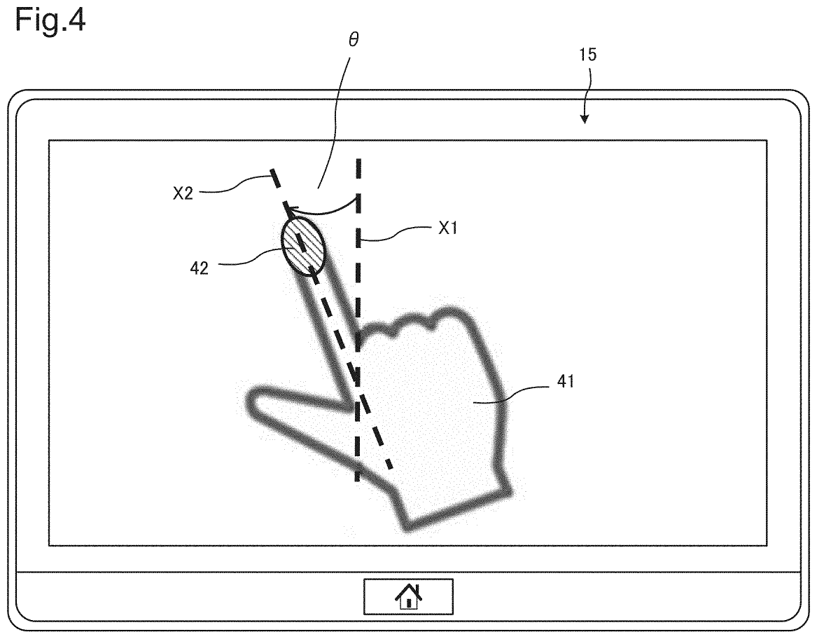

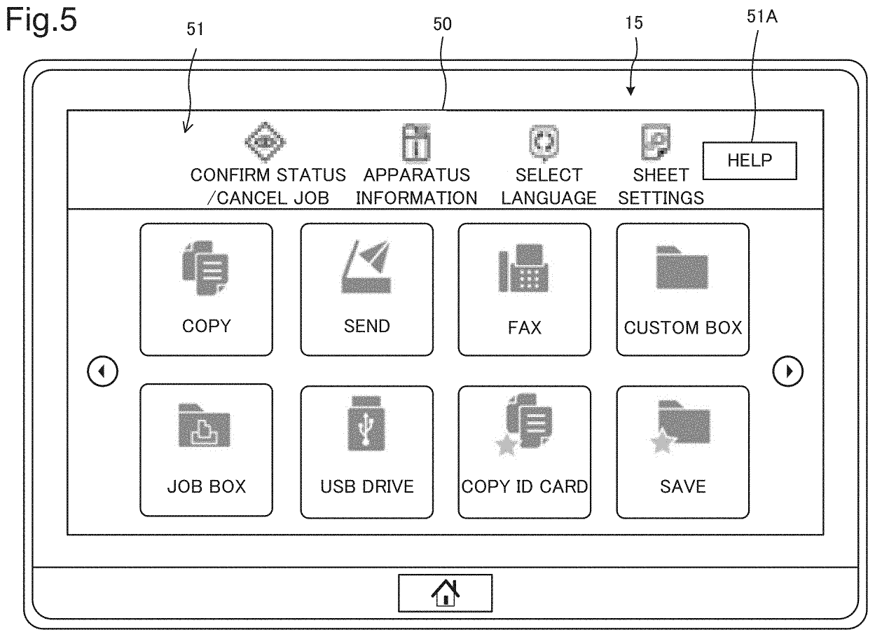

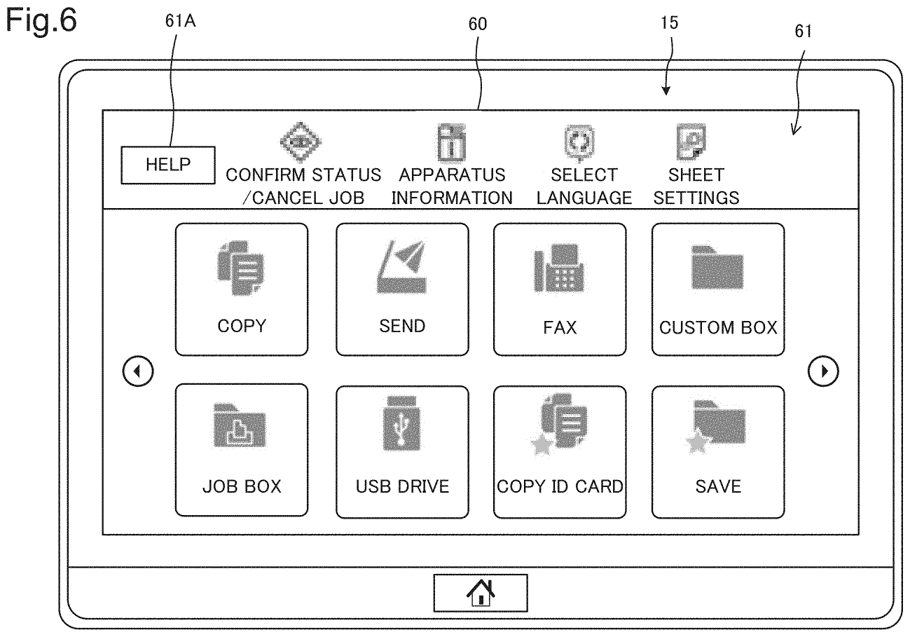

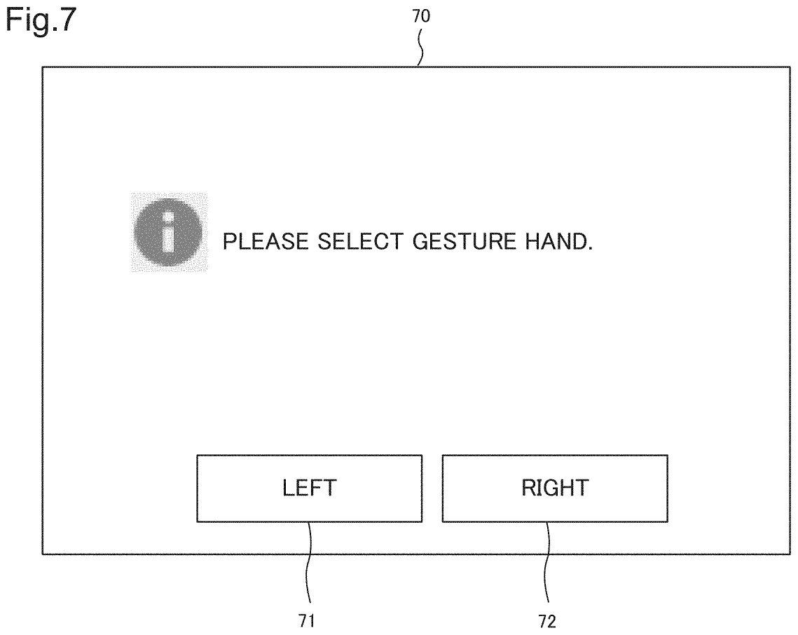

FIG. 3 is a flowchart showing the first gesture hand determination processing. FIG. 4 is a view showing an example of a touch gesture on the touch panel 16A. FIG. 5 is a view showing an example of a first screen. FIG. 6 is a view showing an example of a second screen. FIG. 7 is a view showing an example of a check screen. A description will be given below of the operation of the image forming apparatus 1 when the first gesture hand determination processing is executed, with reference to FIGS. 3 to 7 and so on.

In the first embodiment, in determining whether the gesture hand is the right hand or the left hand, the controller 10 uses a first characteristic that when a user's hand having made a touch gesture on the touch panel 16A is the right hand, the shape of a detection area of the touch gesture on the touch panel 16A (i.e., an area of contact of the touch panel 16A with a user's finger) tilts counterclockwise relative to a reference axis extending in a vertical direction of the display area, and that when the user's hand having made the touch gesture is the left hand, the shape of the detection area of the touch gesture tilts clockwise relative to the reference axis.

When the image forming apparatus 1 is powered on, the controller 10 starts the execution of the first gesture hand determination processing shown in FIG. 3. When starting the execution of the first gesture hand determination processing, the controller 10 allows the display 15 to display a first message prompting the user to make a touch gesture, for example, “PLEASE TOUCH THE TOUCH PANEL”, (step S11). After the processing in step S11, the controller 10 repeats processing resulting in a determination that no touch gesture has been accepted (NO in step S12) until the touch panel 16A detects a touch gesture.

(1) When Gesture Hand is Right Hand

In the above circumstances, assume that, as shown in FIG. 4, the user has touched the touch panel 16A with the index finger of the right hand 41. When the touch panel 16A detects the touch gesture, the controller 10 determines that the touch gesture has been accepted (YES in step S12), and acquires a detection area of the touch gesture on the touch panel 16A (step S13). In this case, the controller 10 acquires an elliptic detection area 42.

After the processing in step S13, the controller 10 determines whether or not the acquired detection area is elliptic (step S14). In this case, the controller 10 determines that the acquired detection area 42 is elliptic (YES in step S14), and calculates the angle θ formed by a predetermined reference axis X1 and the major axis X2 of the detection area (step S15). In this case, the controller 10 sets as the reference axis X1 an axis extending in a vertical direction of the display area (i.e., along the short side of the display area) of the display 15.

Here, it will be assumed that the controller 10 calculates the angle measured clockwise from the reference axis X1 as a positive value and calculates the angle measured counterclockwise from the reference axis X1 as a negative value. In this case, assume that the controller 10 has calculated “−20” degrees as the angle θ. After the processing in step S15, the controller 10 determines whether or not the calculated angle is a counterclockwise angle (step S16).

In this case, since the calculated angle is a negative value, the controller 10 determines that the calculated angle θ is a counterclockwise angle, i.e., the user's gesture hand is the right hand (YES in step S16), and allows the display 15 to display a first screen predetermined for right-hand gesture operation in the display area (step S17).

In this case, as shown in FIG. 5, the controller 10 allows the display 15 to display in the display area a home screen 50 in which a Help button MA and other icons, which are predetermined soft keys contained in an area 51, are arranged closer to one end of the display area of the display 15 in the longitudinal direction, i.e., to the right end of the display area, as the first screen. After the processing in step S17, the controller 10 ends the first gesture hand determination processing.

(2) When Gesture Hand is Left Hand

On the other hand, assume that the user has touched the touch panel 16A with the index finger of the left hand. When the touch panel 16A detects the touch gesture, the controller 10 determines that the touch gesture has been accepted (YES in step S12), and executes the processing from step S13 to step S15 in the same manner as described above. In this case, assume that the controller 10 has calculated “+20” degrees as the angle θ.

In this case, since the calculated angle is a positive value, the controller 10 determines that the calculated angle θ is not a counterclockwise angle, but a clockwise angle, i.e., the user's gesture hand is the left hand (NO in step S16), and allows the display 15 to display a second screen predetermined for left-hand gesture operation in the display area (step S18).

In this case, as shown in FIG. 6, the controller 10 allows the display 15 to display in the display area a home screen 60 in which a Help button 61A and other icons contained in an area 61 are arranged closer to the other end of the display area of the display 15 in the longitudinal direction, i.e., to the left end of the display area, as the second screen. After the processing in step S18, the controller 10 ends the first gesture hand determination processing.

(3) When Gesture Hand Cannot be Identified

When determining that the acquired detection area is not elliptic (NO in step S14), i.e., when the user's gesture hand cannot be identified, the controller 10 allows the display 15 to display, as shown in FIG. 7, a check screen 70 containing a soft key 71 for selecting the left hand as the gesture hand and a soft key 72 for selecting the right hand as the gesture hand in the display area (step S19).

After the processing in step S19, the controller 10 repeats processing resulting in a determination that no instruction to select the right hand as the gesture hand has been accepted (NO in step S20) and processing resulting in a determination that no instruction to select the left hand as the gesture hand has been accepted (NO in step S21), until the soft key 71 or the soft key 72 is touched.

When in this situation the user touches the soft key 72, the controller 10 determines that an instruction to select the right hand has been accepted (YES in step S20), and goes to the processing in step S17. On the other hand, when the user touches the soft key 71, the controller 10 determines that an instruction to select the left hand has been accepted (YES in step S21), and goes to the processing in step S18.

In the above general technique, it is necessary to previously register biological information or like information on many users for use in identifying a user's gesture hand, which takes a lot of work. In addition, if biological information or like information on a user has not been previously registered, the hand of the user having made a gesture cannot be identified, which invites a problem that any screen suitable for the gesture hand cannot be displayed.

Unlike the above, in the first embodiment, the controller 10 determines, based on a detection area of a touch gesture on the touch panel 16A, whether the gesture hand of the user is the right hand or the left hand. When determining that the gesture hand is the right hand, the controller 10 allows the display 15 to display the home screen 50 as the first screen. When determining that the gesture hand is the left hand, the controller 10 allows the display 15 to display the home screen 60 as the second screen.

Specifically, when the detection area 42 of a touch gesture on the touch panel 16A is elliptic, the controller 10 calculates the angle θ formed by the reference axis X1 and the major axis X2 of the detection area 42. When the angle θ is a counterclockwise angle, the controller 10 determines the gesture hand to be the right hand. When the angle θ is a clockwise angle, the controller 10 determines the gesture hand to be the left hand.

Since, as just described, the gesture hand of the user is identified based on the detection area of the touch gesture according to the above-described first characteristic, the gesture hand of the user can be identified without the need to previously register biological information or like information and a screen suitable for the identified gesture hand can be displayed.

Furthermore, in the first embodiment, when the controller 10 fails to identify the gesture hand and instead accepts an instruction to select the right hand as the gesture hand through the touch panel 16A, the controller 10 allows the display 15 to display the home screen 50. When the controller 10 fails to identify the gesture hand and instead accepts an instruction to select the left hand as the gesture hand through the touch panel 16A, the controller 10 allows the display 15 to display the home screen 60.

In this manner, even when the gesture hand cannot be identified based on the detection area of the touch gesture, the user can allow the display 15 to display a screen suitable for the gesture hand by inputting an instruction for identifying the gesture hand using the touch panel 16A. Therefore, the user-friendliness can be increased.

In addition, in the first embodiment, the image forming apparatus 1 includes the display device 2 and the image forming device 12. Thus, a screen for use in inputting an instruction or necessary matters for executing image formation can be displayed suitably for the gesture hand on the display 15. Therefore, an image forming apparatus having excellent user-friendliness can be provided.

### Second Embodiment

An image forming apparatus 1 according to a second embodiment of the present disclosure has the same configuration as the image forming apparatus 1 according to the first embodiment, except that the HDD 18 holds, instead of the first determination program, a second determination program for executing second gesture hand determination processing. Hereinafter, a description will be given of the image forming apparatus 1 according to the second embodiment, focusing on differences from the first embodiment.

In the second embodiment, when operating in accordance with the second determination program, the controller 10 executes second gesture hand determination processing of determining, based on the starting point and the ending point of a swipe gesture of a user on the touch panel 16A, whether the gesture hand of the user is the right hand or the left hand, and (i) allowing the display 15 to display the first screen when determining that the gesture hand is the right hand or (ii) allowing the display 15 to display the second screen when determining that the gesture hand is the left hand.

[Operations]

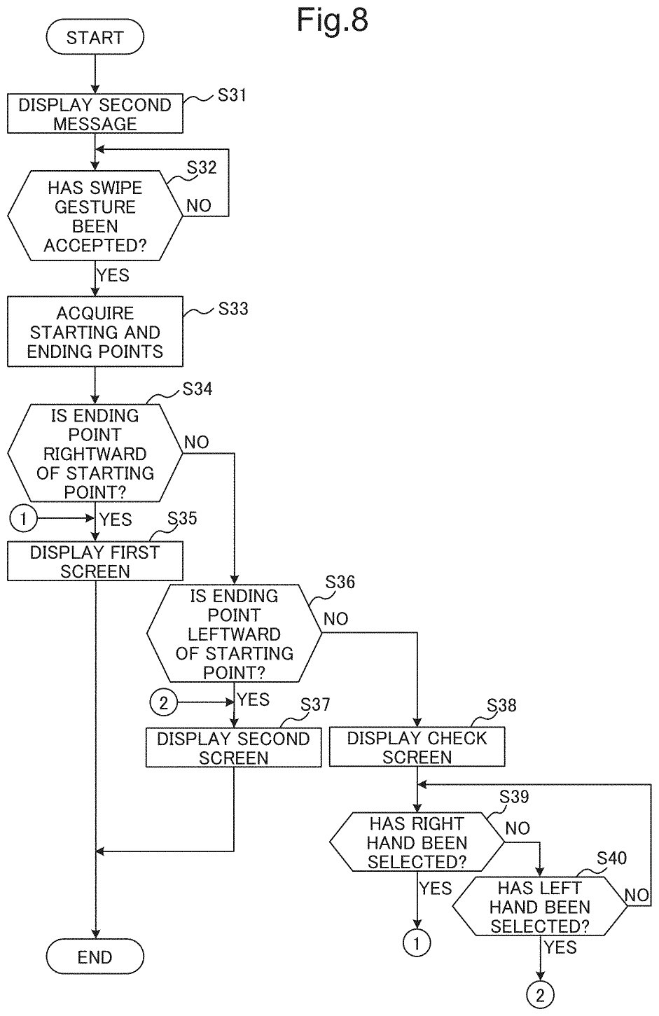

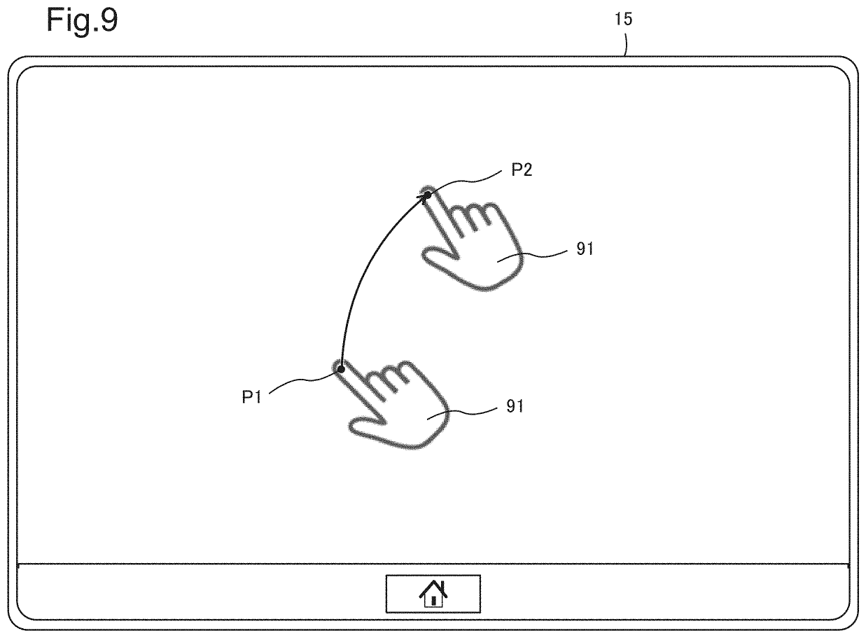

FIG. 8 is a flowchart showing the second gesture hand determination processing. FIG. 9 is a view showing an example of a swipe gesture on the touch panel 16A. A description will be given below of the operation of the image forming apparatus 1 when the second gesture hand determination processing is executed, with reference to FIGS. 8 and 9 and so on.

In the second embodiment, in determining whether the gesture hand is the right hand or the left hand, the controller 10 uses a second characteristic that when a user's hand having made a swipe gesture on the touch panel 16A is the right hand, the trajectory of the swipe gesture curves to an upper right portion of the display area (i.e., upward and to the one end of the display area in the longitudinal direction) of the display 15, and that when the user's hand having made the swipe gesture is the left hand, the trajectory of the swipe gesture curves to an upper left portion of the display area (i.e., upward and to the other end of the display area in the longitudinal direction) of the display 15.

When the image forming apparatus 1 is powered on, the controller 10 starts the execution of the second gesture hand determination processing shown in FIG. 8. When starting the execution of the second gesture hand determination processing, the controller 10 allows the display 15 to display a second message prompting the user to make a swipe gesture toward the top of the display area of the display 15 (i.e., toward one end of the display area in the direction along the short side), for example, “PLEASE MAKE UPWARD SWIPE GESTURE ON TOUCH PANEL”, (step S31). After the processing in step S31, the controller 10 repeats processing resulting in a determination that no swipe gesture has been accepted (NO in step S32) until the touch panel 16A detects an upward swipe gesture.

(1) When Gesture Hand is Right Hand

In the above circumstances, assume that, as shown in FIG. 9, the user has swiped on the touch panel 16A with the index finger of the right hand 91. When the touch panel 16A detects the swipe gesture, the controller 10 determines that the swipe gesture has been accepted (YES in step S32), and acquires the coordinates of the starting point and ending point of the swipe gesture on the touch panel 16A (step S33). In this case, as shown in FIG. 9, assume that the controller 10 has acquired as the coordinate of the ending point P2 of the swipe gesture a coordinate indicating a location rightward of a location indicated by the coordinate of the starting point P1 in the display area of the display 15 (i.e., a location closer to the one end of the display area in the longitudinal direction than the coordinate of the starting point P1).

After the processing in step S33, the controller 10 determines whether or not the acquired ending point is located rightward of the starting point in the display area (step S34). In this case, the controller 10 determines that the ending point P2 is located rightward of the starting point P1 in the display area, i.e., the user's gesture hand is the right hand (YES in step S34), and allows the display 15 to display the home screen 50 shown in FIG. 5 as the first screen in the display area (step S35). After the processing in step S35, the controller 10 ends the second gesture hand determination processing.

(2) When Gesture Hand is Left Hand

On the other hand, assume that the user has swiped on the touch panel 16A with the index finger of the left hand. When the touch panel 16A detects the swipe gesture, the controller 10 determines that the swipe gesture has been accepted (YES in step S32), and executes the processing in step S33 in the same manner as described above. In this case, assume that the controller 10 has acquired as the coordinate of the ending point of the swipe gesture a coordinate indicating a location leftward of a location indicated by the coordinate of the starting point in the display area (i.e., a location closer to the other end of the display area in the longitudinal direction than the coordinate of the starting point).

After the processing in step S33, the controller 10 determines that the acquired ending point is not located rightward of the starting point in the display area (NO in step S34), then determines that the acquired ending point is located leftward of the starting point in the display area, i.e., the user's gesture hand is the left hand (YES in step S36), and allows the display 15 to display the home screen 60 shown in FIG. 6 as the second screen in the display area (step S37). After the processing in step S37, the controller 10 ends the second gesture hand determination processing.

(3) When Gesture Hand Cannot be Identified

When determining that the acquired ending point is located neither rightward nor leftward of the starting point in the display area (NO in step S34 and NO in step S36), i.e., when the user's gesture hand cannot be identified, the controller 10 allows the display 15 to display the check screen 70 shown in FIG. 7 in the display area (step S38).

After the processing in step S38, the controller 10 repeats processing resulting in a determination that no instruction to select the right hand as the gesture hand has been accepted (NO in step S39) and processing resulting in a determination that no instruction to select the left hand as the gesture hand has been accepted (NO in step S40), until the soft key 71 or the soft key 72 is touched.

When in this situation the user touches the soft key 72, the controller 10 determines that an instruction to select the right hand has been accepted (YES in step S39), and goes to the processing in step S35. On the other hand, when the user touches the soft key 71, the controller 10 determines that an instruction to select the left hand has been accepted (YES in step S40), and goes to the processing in step S37.

In the second embodiment, the controller 10 determines, based on the starting point and ending point of a swipe gesture on the touch panel 16A, whether the gesture hand of the user is the right hand or the left hand. When determining that the gesture hand is the right hand, the controller 10 allows the display 15 to display the home screen 50 as the first screen. When determining that the gesture hand is the left hand, the controller 10 allows the display 15 to display the home screen 60 as the second screen.

Specifically, when the ending point of a swipe gesture on the touch panel 16A is located rightward of the starting point of the swipe gesture in the display area, the controller 10 determines that the gesture hand is the right hand. When the ending point of the swipe gesture is located leftward of the starting point of the swipe gesture in the display area, the controller 10 determines that the gesture hand is the left hand.

Since, as just described, the gesture hand of the user is identified based on the starting point and ending point of the swipe gesture according to the above-described second characteristic, the gesture hand of the user can be identified without the need to previously register biological information or like information and a screen suitable for the identified gesture hand can be displayed.

(Modifications)

Although in the above first and second embodiments a home screen is illustrated as the first screen and the second screen, the present disclosure is not limited to the manner described in the above embodiments. For example, the first screen and the second screen may be a setting screen for use in configuring settings for the copy function or the facsimile function.

Although in the first and second embodiments the shape of the display area of the display 15 is a horizontally long shape, the present disclosure is not limited to the shape described in the above embodiments. For example, the shape of the display area may be a vertically long shape.

In the first and second embodiments, when the gesture hand cannot be identified, the controller 10 allows the display 15 to display the check screen 70 in the display area. However, the present disclosure is not limited to the manner described in the above embodiments. For example, when the gesture hand cannot be identified, the controller 10 may allow the display 15 to display the first screen and additionally display a check message asking the user whether to select the left hand as the gesture hand.

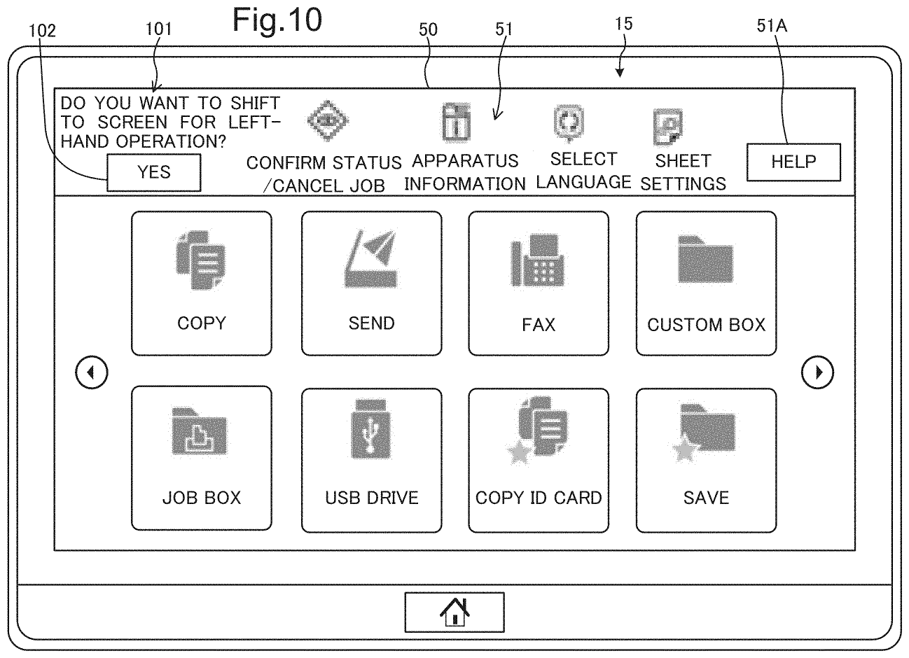

FIG. 10 is a view showing another example of the first screen. In this case, as shown in FIG. 10, the controller 10 allows the display 15 to display the home screen 50 as the first screen and additionally display a check message 101. When the user touches a shift key 102, the controller 10 determines, through the touch panel 16A, that an instruction to select the left hand as the gesture hand has been accepted, and allows the display 15 to display, instead of the home screen 50, the home screen 60 as the second screen.

The present disclosure is not limited to the structure of the above embodiments and can be modified in various ways. For example, although in the above embodiments the image forming apparatus 1 serving as a multicolor multifunction peripheral is used as the image forming apparatus, it is merely illustrative and any other image forming apparatuses, such as a black-and-white multifunction peripheral, a copier, and a facsimile machine, may be used.

Furthermore, although in the above embodiments the display device 2 included in the image forming apparatus 1 is used as the display device, it is merely illustrative and any other display devices, such as a tablet terminal and a smartphone, may be used.

Although in the above embodiments the image forming device 12 and so on form an image on a recording paper sheet P, the present disclosure is not limited to the manner described in the above embodiments. The image forming device 12 and so on may form an image on recording media other than a recording paper sheet. An example of the other recording media is an OHP (overhead projector) sheet.

The structures, configurations, and processing described in the above embodiments with reference to FIGS. 1 to 10 are merely illustrative and are not intended to limit the present disclosure to them.

While the present disclosure has been described in detail with reference to the embodiments thereof, it would be apparent to those skilled in the art the various changes and modifications may be made therein within the scope defined by the appended claims.

What is claimed is:

1. A display device comprising:
a display that displays a screen in a display area thereof;
a touch panel superposed on a top of the display area; and
a control device including a processor and functioning, through the processor executing a control program, as a controller that determines, based on a detection result of a gesture on the touch panel, whether a hand of a user having made the gesture is a right hand or a left hand, and allows the display to display a first screen predetermined for gesture operation with a right hand when determining that the hand having made the gesture is the right hand, or allows the display to display a second screen predetermined for gesture operation with a left hand when determining that the hand having made the gesture is the left hand.

2. The display device according to claim 1, wherein
when a detection area of a touch gesture on the touch panel is elliptic, the controller calculates an angle formed by a predetermined reference axis extending in a vertical direction of the display area and a major axis of the detection area,
when the angle is a counterclockwise angle, the controller determines the hand having made the gesture to be the right hand, and
when the angle is a clockwise angle, the controller determines the hand having made the gesture to be the left hand.

3. The display device according to claim 1, wherein
when an ending point of a swipe gesture on the touch panel is located rightward of a starting point of the swipe gesture in the display area, the controller determines the hand having made the gesture to be the right hand, and
when the ending point of the swipe gesture is located leftward of the starting point of the swipe gesture in the display area, the controller determines the hand having made the gesture to be the left hand.

4. The display device according to claim 1, wherein
when the controller fails to identify the hand having made the gesture and accepts an instruction to select the right hand as the hand having made the gesture through the touch panel, the controller allows the display to display the first screen, and
when the controller fails to identify the hand having made the gesture and accepts an instruction to select the left hand as the hand having made the gesture through the touch panel, the controller allows the display to display the second screen.

5. The display device according to claim 1, wherein
when the controller fails to identify the hand having made the gesture, the controller allows the display to display the first screen and additionally display a message asking whether to select the left hand as the hand having made the gesture, and
when the controller accepts through the touch panel an instruction to select the left hand as the hand having made the gesture, the controller allows the display to switch from the first screen to the second screen.

6. The display device according to claim 1, wherein the controller allows the display to display as the first screen a screen where a predetermined soft key is disposed closer to a right end of the display area, or display as the second screen a screen where the predetermined soft key is disposed closer to a left end of the display area.

7. An image forming apparatus comprising:
the display device according to claim 1; and
an image forming device that forms an image on a recording medium.
